(19) United States
(12) Patent Application Publication
(10) Pub. No.: US 2026/0133547 A1
(43) Pub. Date: May 14, 2026

(54) ARTIFICIAL INTELLIGENCE DEVICE FOR MAINTAINING PERSONALITY ASSIGNMENT IN LARGE LANGUAGE MODEL ROLE-PLAYING DIALOGUE AGENTS AND METHOD THEREOF

(71) Applicant: LG ELECTRONICS INC., Seoul (KR)

(72) Inventors: Yixiao WANG, Toronto (CA); Homa FASHANDI, Toronto (CA)

(73) Assignee: LG ELECTRONICS INC., Seoul (KR)

(21) Appl. No.: 19/380,365

(22) Filed: Nov. 5, 2025

Related U.S. Application Data
(60) Provisional application No. 63/716,679, filed on Nov. 5, 2024.

(51) Int. Cl. G05B 13/02

(52) U.S. Cl. CPC G05B 13/027

(57) ABSTRACT

A method for controlling an artificial intelligence (AI) device can include assigning a target personality profile to a large language model (LLM) dialogue agent, engaging in one or more interactions with a user via the LLM dialogue agent, in response to a predetermined condition being met, providing a sequential series of individual assessment prompts to the LLM dialogue agent for a multi-part personality assessment in a one-at-a-time (OAAT) manner, generating, by the LLM dialogue agent, a plurality of responses respectively corresponding to the sequential series of individual assessment prompts, determining a current personality profile of the LLM dialogue agent based on the plurality of responses, determining a deviation metric based the current personality profile and the target personality profile, and in response to the deviation metric exceeding a predefined threshold, triggering a personality re-alignment process for aligning the LLM dialogue agent with the target personality profile.

### CROSS-REFERENCE TO RELATED APPLICATIONS

This non-provisional application claims priority under 35 U.S.C. § 119(e) to U.S. Provisional Application No. 63/716,679, filed on Nov. 5, 2024, the entirety of which is hereby expressly incorporated by reference into the present application.

### BACKGROUND

### Field

The present disclosure relates to a device and method for maintaining personality consistency in large language model (LLM) dialogue agents, in the field of artificial intelligence (AI). Particularly, the method can implement a framework that utilizes a one-at-a-time (OAAT) assessment strategy with a Logic-of-Thought (LoT) reasoning process to provide enhanced personality alignment and real-time correction of personality drift even on resource constrained devices.

### Discussion of the Related Art

Artificial intelligence (AI) has seen significant advancements, particularly with the development of Large Language Models (LLMs). These models have evolved from simple text generators into sophisticated dialogue agents, including Role-Playing Dialogue Agents (RPDAs). A key trend in the field is the deployment of these agents on resource constrained or edge devices, such as smartphones, smart home appliances and in-vehicle infotainment systems, to provide users with low-latency, private and even offline capable interactions.

While these on-device agents are promising, they often rely on small large language models (sLLMs) which introduces significant technical challenges. These sLLMs often undergo quantization (e.g., to 4-bit or 8-bit precision) to be able operate within the computational and memory limitations of edge devices, which can impair their performance. One issue is that these sLLMs may struggle to maintain a consistent personality.

For example, an agent assigned a specific persona, such as a “cheerful and supportive assistant,” may drift over the course of an extended conversation or long session. For example, this personality drift can be caused by the model being influenced by the user. For instance, the sLLM may begin to mirror the user's own personality or style, rather than adhering to its assigned persona. As a result, the agent may revert to a generic or out-of-character tone, or even adopt a new, unintended persona influenced by the user. This personality drift can degrade the user experience and undermine the agent's intended function.

This lack of personality consistency remains a challenge. For example, a user interacting with a branded virtual assistant for a premium product designed to be “calm, professional and formal,” may lose user trust if it begins generating overly casual or erratic replies. Existing solutions, such as relying on a single, static system prompt (e.g., “You are a helpful assistant who is extroverted and conscientious”), are insufficient as their influence diminishes as the conversational context window grows ever larger.

Further challenges exist due to the absence of a computationally efficient framework for monitoring and correcting this personality drift in real-time on the edge device itself. Existing methods for personality assessment are often too complex for an sLLM to answer accurately in a single pass. Further, evaluating the agent's alignment might require resource intensive computations or calls to a much larger, server-based model, which re-introduces the latency, privacy and connectivity issues that on-device deployment is intended to address. Existing methods therefore lack a systematic way to effectively and efficiently quantify personality drift and trigger an effective, on-device re-alignment.

Thus, a need exists for an improved method and device that can enable small large language model (sLLM) dialogue agents to maintain a consistent, assigned personality profile throughout an extended user interaction even on resource constrained edge devices.

Furthermore, a need exists for a framework that can accurately and efficiently assess the sLLM's current personality state. Such a method is needed to overcome the cognitive limitations of sLLMs in handling complex, multi-part assessment tasks, and to provide a robust assessment that can even be executed on an edge device without reliance on external server computation.

Also, a need exists for a comprehensive framework that can systematically monitor the agent's personality alignment in real-time, quantitatively measure any deviation or drift from its target persona, and automatically trigger an effective, on-device re-alignment process to better ensure a stable and consistent personality for the dialogue agent.

### SUMMARY OF THE DISCLOSURE

The present disclosure has been made in view of the above problems and it is an object of the present disclosure to provide a device and method that can provide improved personality consistency for large language model (LLM) dialogue agents. Further, the method can provide enhanced personality alignment by implementing a framework that utilizes a “one-at-a-time” (OAAT) assessment strategy and a “Logic-of-Thought” (LoT) reasoning process to accurately assess the agent's personality and quantitatively measure and correct personality drift.

An object of the present disclosure is to provide an artificial intelligence (AI) device and method for maintaining personality alignment in a dialogue agent powered by a small large language model (sLLM), even on a resource constrained device. The method can utilize a closed loop monitoring and correction framework to systematically assess and remediate personality drift in real-time. For example, an initial target personality profile that is defined by a set of traits can first be assigned to the dialogue agent. Then, as the agent engages in a conversational dialogue, its adherence to the target profile can be monitored by performing a personality assessment at predetermined intervals. This assessment can include presenting a series of individual assessment prompts to the sLLM using a “one-at-a-time” (OAAT) strategy and guiding the sLLM to generate a response for each prompt by applying a “Logic-of-Thought” (LoT) framework, in which the LoT framework provides explicit reasoning steps linking the prompt to a specific personality trait. A current personality profile can be calculated based on the assessment responses and a deviation metric can be computed by comparing this current profile against the target personality profile. A personality re-alignment process can be triggered if the computed deviation metric exceeds a predefined threshold. This can produce a highly consistent and stable personality for the agent even when deployed on an edge device while also providing a quantitative measure of alignment, thereby enhancing user trust and overall utility.

Another object of the present disclosure is to provide a method for controlling an artificial intelligence (AI) device that can include assigning, by a processor in the AI device, a target personality profile to a large language model (LLM) dialogue agent, the target personality profile including one or more personality traits, engaging in one or more interactions with a user via the LLM dialogue agent, in response to a predetermined condition being met, providing a sequential series of individual assessment prompts to the LLM dialogue agent for a multi-part personality assessment in a one-at-a-time (OAAT) manner, generating, by the LLM dialogue agent, a plurality of responses respectively corresponding to the sequential series of individual assessment prompts, determining a current personality profile of the LLM dialogue agent based on the plurality of responses, determining a deviation metric based the current personality profile and the target personality profile, and in response to the deviation metric exceeding a predefined threshold, triggering a personality re-alignment process for aligning the LLM dialogue agent with the target personality profile.

It is another object of the present disclosure to provide a method, in which the predetermined condition includes a conversational turn counter incremented after each of the one or more interactions being evenly divisible by a predefined monitoring frequency value, or the predetermined condition includes a predetermined time interval.

Yet another object of the present disclosure is to provide a method, in which each of the individual assessment prompts includes combining an individual assessment prompt with a Logic-of-Thought (LoT) reasoning framework that provides an explicit logical connection between the individual assessment prompt and a corresponding one of the one or more personality traits.

An object of the present disclosure is to provide a method, in which the LLM dialogue agent is a small large language model (sLLM) having less than 9 billion parameters.

Another object of the present disclosure is to provide a method, in which the multi-part personality assessment includes a big five inventory (BFI) assessment with dimensions based on openness, conscientiousness, extraversion, agreeableness, and neuroticism (OCEAN).

An object of the present disclosure is to provide a method, in which the determining the deviation metric includes calculating a normalized BFI Error (NBE) based on an absolute difference between a trait value in the current personality profile and a corresponding trait value in the target personality profile.

Yet another object of the present disclosure is to provide a method in which the NBE is determined according to equation:

$$NBE = \frac{1}{n} \text{?} \frac{1}{5} \text{?} \vert {T}_{j} - Norm ( {S}_{i , j} ) \vert ,$$

$$\text{?} \text{indicates text missing or illegible when filed}$$

where n is a number of evaluation runs, j is a positive integer, Tⱼ is a target assigned trait value for an j-th BFI trait, Norm(S_{i,j}) indicates that S_{i,j} is a self-evaluation score of the j-th BFI trait in i-th evaluation run, normalized to a corresponding BFI scale.

An object of the present disclosure is to provide a method, in which the personality re-alignment process includes reinforcing the target personality profile by providing one or more system prompts to the LLM dialogue agent.

Another object of the present disclosure is to provide a method, in which the personality re-alignment process includes modifying a conversational history by selectively pruning, modifying, or discarding at least a portion of the one or more interactions determined to have caused a deviation from the target personality profile.

An object of the present disclosure is to provide a method, in which the personality re-alignment process includes applying a personality specific model adapter to modify one or more model parameters of the LLM dialogue agent.

Another object of the present disclosure is to provide an artificial intelligence (AI) device including a memory configured to store information for a large language model, and a controller configured to assign a target personality profile to a large language model (LLM) dialogue agent, the target personality profile including one or more personality traits, engage in one or more interactions with a user via the LLM dialogue agent, in response to a predetermined condition being met, provide a sequential series of individual assessment prompts to the LLM dialogue agent for a multi-part personality assessment in a one-at-a-time (OAAT) manner, generate, by the LLM dialogue agent, a plurality of responses respectively corresponding to the sequential series of individual assessment prompts, determine a current personality profile of the LLM dialogue agent based on the plurality of responses, determine a deviation metric based the current personality profile and the target personality profile, and in response to the deviation metric exceeding a predefined threshold, trigger a personality re-alignment process for aligning the LLM dialogue agent with the target personality profile.

An object of the present disclosure is to provide a non-transitory computer readable medium storing computer-executable instructions that when executed by a processor, cause the processor to perform the operations of assigning a target personality profile to a large language model (LLM) dialogue agent, the target personality profile including one or more personality traits, engaging in one or more interactions with a user via the LLM dialogue agent, in response to a predetermined condition being met, providing a sequential series of individual assessment prompts to the LLM dialogue agent for a multi-part personality assessment in a one-at-a-time (OAAT) manner, generating, by the LLM dialogue agent, a plurality of responses respectively corresponding to the sequential series of individual assessment prompts, determining a current personality profile of the LLM dialogue agent based on the plurality of responses, determining a deviation metric based the current personality profile and the target personality profile, and in response to the deviation metric exceeding a predefined threshold, triggering a personality re-alignment process for aligning the LLM dialogue agent with the target personality profile.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an example workflow for evaluating and improving personality alignment in Large Language Models (LLMs) according to an embodiment of the present disclosure

FIG. 7 illustrates an example flow chart for a method of controlling an AI device according to an embodiment of the present disclosure.

FIG. 8 illustrates an example methodology for exploring the accuracy of the assigned personality of small Large Language Models (sLLMs) according to an embodiment of the present disclosure.

FIG. 9, including parts (a)-(f), illustrate examples of OCEAN personality score plots of how different methods perform in aligning sLLMs with the assigned personality traits, according to embodiments of the present disclosure.

FIG. 10, including parts (a)-(f), illustrate examples of OCEAN personality score plots of how different methods perform in aligning sLLMs with the assigned personality traits, according to embodiments of the present disclosure.

FIG. 11, including parts (a)-(f), illustrate examples of OCEAN personality score plots of how different methods perform in aligning sLLMs with the assigned personality traits, according to embodiments of the present disclosure.

FIG. 12 shows evaluation results for sLLMs using various strategies and bit depths, according to embodiments of the present disclosure.

FIG. 13 shows evaluation results for sLLMs that are even smaller using various strategies and bit depths, according to embodiments of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

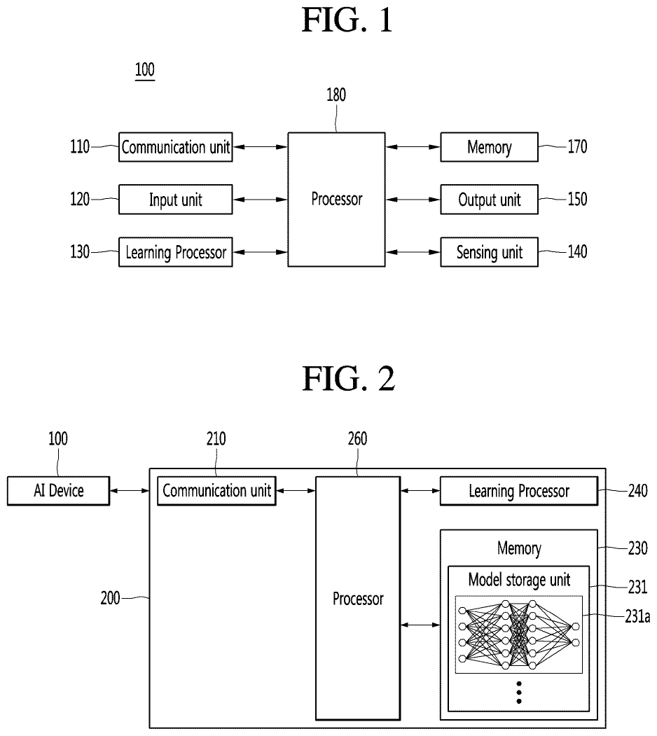

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

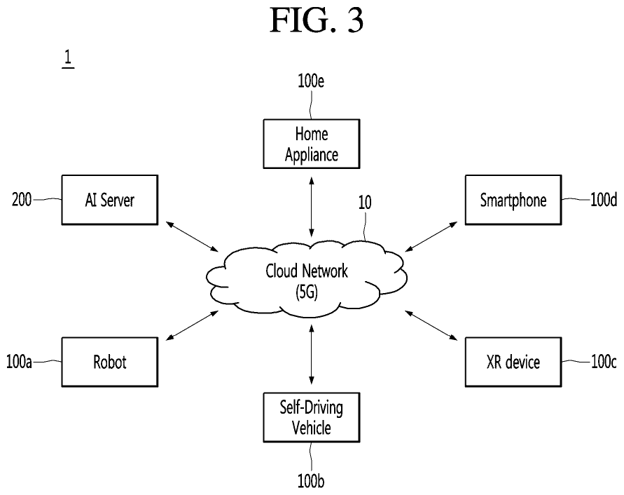

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generation (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 (e.g., transceiver, or communication interface) can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of a large language model (LLM), a small large language model (sLLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's personal preferences.

According to an embodiment, the AI device 100 can provide a method for maintaining personality alignment in a dialogue agent powered by a small large language model (sLLM) by performing a personality assessment, and triggering a re-alignment process when a determined deviation from a target personality exceeds a predefined threshold.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for maintaining personality alignment in small large language model (sLLM) dialogue agents to ensure their reliability and consistency during extended conversations even on resource constrained devices.

For example, embodiments of the present disclosure can provide for a real-time personality alignment and monitoring framework for sLLM-powered dialogue agents, which can be viewed as a foundational component for applications requiring high-trust, consistent, and on-device user interaction, such as personalized digital assistants on mobile devices, in-vehicle infotainment systems, smart home appliances, educational tutors, and therapeutic or companion agents where personality stability is desirable for the user experience.

As discussed above, the deployment of dialogue agents on resource constrained edge devices faces several technical challenges. The performance, reliability and user trust in such agents (e.g., Role-Playing Dialogue Agents (RPDAs) or branded assistants) are dependent on their ability to establish and maintain a consistent, predefined personality profile over time.

To be functional on edge devices (e.g., smartphones, smart speakers, in-vehicle infotainment systems), large language models (LLMs) can be compressed into small LLMs (sLLMs) through quantization (e.g., to 8-bit, 4-bit, or lower precision). This compression often has a detrimental effect on the model's capabilities. A significant problem that can arise is “personality drift” or “personality collapse,” where the quantized sLLM progressively loses its assigned persona during a dynamic, multi-turn conversation, regressing toward a generic or inconsistent state.

One approach to instilling personality involves defining the desired traits within the agent's initial system prompt (e.g., “You are a witty and sarcastic assistant”). However, this technique is often insufficient to prevent personality drift in sLLMs, particularly as the conversational context accumulates over time. For example, the system prompt acts as a static instruction and its influence may diminish over a long interaction. This approach lacks a mechanism for active, continuous reinforcement and adjustment, especially in response to user inputs that may pull the agent off character or unduly influence its assigned personality.

Another approach involves fine-tuning a base sLLM on a curated dataset that exemplifies the target personality. However, this process can be computationally expensive and create a rigid, specialized model. Further, this resulting model can still experience personality drift, especially after undergoing quantization for on-device deployment. Fine-tuning does not provide the sLLM with an active, real-time mechanism to manage or correct its personality during a live interaction, and it can still lose behavioral consistency when faced with novel conversational paths.

A further challenge in the existing art is the absence of a computationally efficient and reliable framework for assessing an sLLM's personality alignment on the device. Existing methods often present a full set of questions in a single prompt, which may fail when applied to sLLMs. The limited reasoning capacity of these smaller models makes them unable to process such a complex, multi-part query at once which can lead to inaccurate or nonsensical assessment results.

Also, making remote calls to a much larger, server-based LLM to perform the assessment or the dialogue itself, defeats the purpose of an on-device agent and re-introduces issues of latency, user privacy and reliance on network connectivity.

Thus, a need exists for an improved device and method that can efficiently and accurately assess an sLLM's personality alignment in real-time even on an edge device. A further need exists for a method that can use this assessment to quantitatively measure personality drift and automatically trigger an efficient, on-device re-alignment process that can better ensure the agent's personality remains consistent and stable.

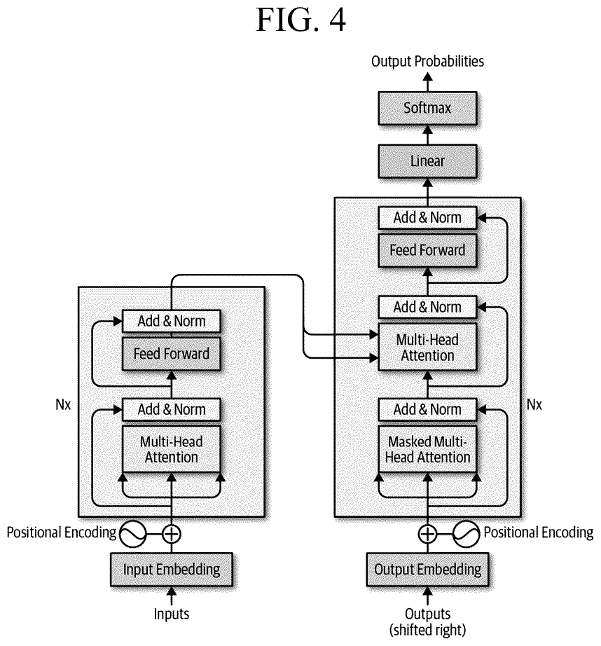

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information to allow the model to capture dependencies and contextual relationships effectively, which is particularly relevant for understanding complex user queries or detailed product descriptions.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics (e.g., an assigned personality). According to embodiments, the AI model can advantageously utilize pre-trained LLMs, potentially without requiring extensive task-specific fine-tuning for its core agent functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a summary, or other contextually relevant content. Also, according to an embodiment, the LLM portion can be multi-modal to accept and operate on other types of input, such as images, video, etc.

In addition, one or more of the various components of the framework can be configured as artificial intelligence agents (e.g., AI agents). For example, an AI agent can be an autonomous computational system designed to process information and take actions to achieve specific goals. An agent can receive inputs, perform reasoning about those inputs based on its internal logic and knowledge, and produce outputs or executes tasks in response. According to embodiments, these agents can range from rule based systems to highly complex models capable of sophisticated reasoning and decision making.

According to an embodiment, the one or more AI agents can be based on Large Language Models (LLMs) that can be endowed with more sophisticated capabilities, such as planning, memory and the ability to use external tools.

For example, a planning module can allow the agent to decompose a high level goal into a sequence of smaller, manageable steps. A memory module can provide the agent with the ability to retain information from past interactions and conversations, allowing it to maintain context and learn over time.

Further, the ability to use external tools can enable the agent to interact with other software, APIs or data sources to gather information or perform actions to execute a wide variety of complex, real-world tasks.

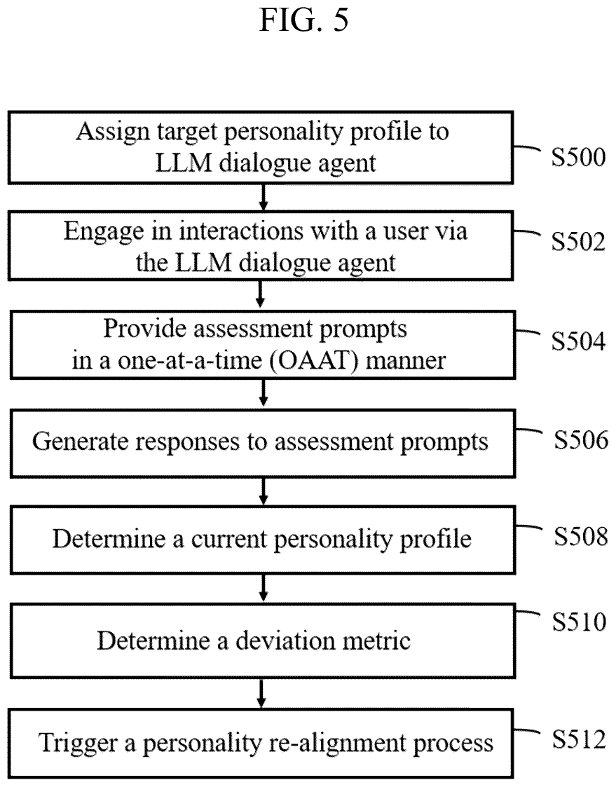

FIG. 5 shows an example flow chart of a method according to an embodiment of the present disclosure. For example, according to an embodiment, a method for controlling an AI device 100 can include assigning, by a processor in the AI device 100, a target personality profile to a large language model (LLM) dialogue agent, the target personality profile including one or more personality traits (e.g., S500), engaging in one or more interactions with a user via the LLM dialogue agent (e.g., S502), in response to a predetermined condition being met, providing a sequential series of individual assessment prompts to the LLM dialogue agent for a multi-part personality assessment in a one-at-a-time (OAAT) manner (e.g., S504), generating, by the LLM dialogue agent, a plurality of responses respectively corresponding to the sequential series of individual assessment prompts (e.g., S506), determining a current personality profile of the LLM dialogue agent based on the plurality of responses (e.g., S508), determining a deviation metric based the current personality profile and the target personality profile (e.g., S510), and in response to the deviation metric exceeding a predefined threshold, triggering a personality re-alignment process for aligning the LLM dialogue agent with the target personality profile (e.g., S512).

For example, according to an embodiment, the AI device 100 can include a dialogue engine, a personality monitoring module, and a personality re-assignment (or re-alignment) module. Also, the method can operate in a continuous loop in which the agent's personality alignment is periodically assessed, and corrective action can be taken if the agent's personality is found to have drifted from its assigned target profile.

For example, in an initial phase, a target personality profile can be assigned to the dialogue agent. This assignment can be achieved through specialized prompt engineering, or by using a model that has been pre-trained or fine-tuned to exhibit the desired personality, or a combination thereof. A monitoring frequency can be defined, which represents a predetermined interval for performing a personality check (e.g., once every 24 hours or after every set of 20 queries from the user, etc.).

As the process proceeds, the dialogue agent can engage in a conversational dialogue with a user for one or more interaction rounds. As noted above, during such multi-round conversations, sLLMs and quantized models may lose their assigned personality and may begin to adopt the personality of the user. To counteract this, the personality monitoring module can be initiated at predetermined intervals.

According to an embodiment, the monitoring process can include performing a personality assessment in which the sLLM is prompted to respond to a series of personality related questions, such as the 44 questions of a Big Five (OCEAN) inventory. The process can then measure the difference or drift between the initially assigned target personality and the agent's current personality, for example, by calculating a deviation metric, such as a Normalized BFI Error (NBE), which is discussed in more detail at a later section.

Further in this example, a check can then be performed to determine if the computed NBE (or other deviation metric) exceeds a predefined threshold. If the computed deviation metric does exceed the threshold (e.g., indicating unacceptable personality drift) the process can trigger the personality re-assignment module to execute a re-alignment process.

In addition, this loop of conversing, monitoring, checking and re-aligning can ensure that the agent's adherence to its persona is actively managed. According to embodiments, the frequency of the monitoring step itself can be dynamically adjusted. For instance, in a model that is detected to experience frequent and turbulent personality shifts, the monitoring step can be performed more often (e.g., by increasing the monitoring frequency).

The personality re-alignment process can be implemented by one or more of a plurality of solutions. In some embodiments, the re-alignment can include modifying the contextual information provided to the sLLM, such as by reinforcing the target personality via system prompts, or by selectively modifying, pruning or discarding portions of the conversational history.

In other embodiments, the re-alignment process can include modifying the sLLM's model parameters, such as by applying or adjusting a fine-tuning or a personality-specific model adapter to steer the agent's behavior back towards the target personality profile.

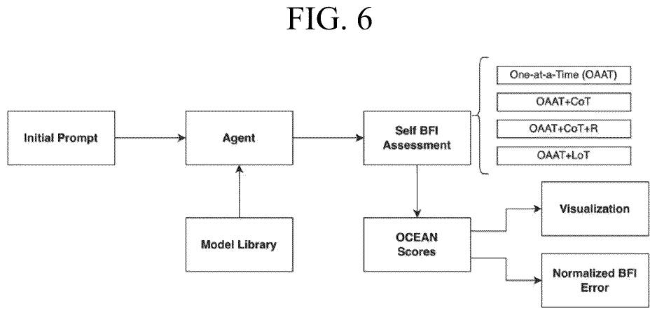

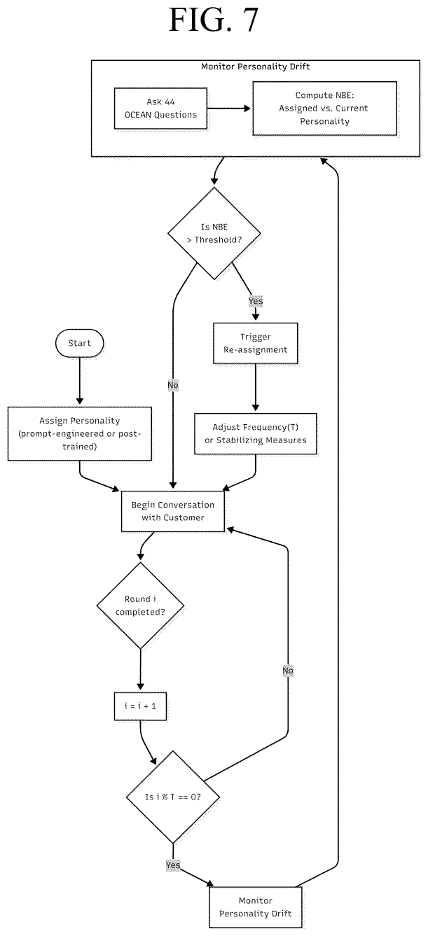

FIG. 6 illustrates an example workflow for evaluating and improving personality alignment in Large Language Models (LLMs) according to an embodiment of the present disclosure.

According to an embodiment, the process can begin with an initial prompt, which can serve as the starting point and can contain instructions for the agent. For example, the initial prompt can include the desired personality profile, including a set of target personality traits (e.g., target OCEAN scores) that the agent is to emulate.

The initial prompt can be provided to the agent. The agent can be configured to interact with other components of the system to perform its tasks. For example, the agent can interface with a model library containing one or more small large language models (sLLMs), which can include quantized sLLMs. The agent can select or be configured with a suitable sLLM from this library to embody the agent and respond to the prompts.

The agent can then proceed to a self BFI assessment module where the agent (running the selected sLLM) assesses its own personality, for example, by generating responses to a series of Big Five Inventory (BFI) questions.

As shown in the FIG. 6, this assessment module can be configured to utilize one of several different strategies to break down the assessment, such as: “One-at-a-Time” (OAAT), “One-at-a-Time with Chain of Thought” (OAAT+CoT), “One-at-a-Time with Chain of Thought and Reference information” (OAAT+CoT+R), or “One-at-a-Time with Logic of Thought” (OAAT+LoT). For example, the OAAT strategy can include decomposing a multi-part assessment into a sequential series of individual prompts where each individual prompt contains substantially one part (e.g., a single question) from the multi-part assessment to be presented to the language model. These various strategies are discussed in more detail along with associated prompts at a later section below.

Further in this example, the result of the self BFI assessment can include a set of OCEAN Scores. These scores represent the measured, current personality traits of the agent in terms of openness, conscientiousness, extraversion, agreeableness, and neuroticism. However, embodiments are not limited thereto and other types of scoring can be used, such as Myers-Briggs Type Indicator (MBTI) or Honesty-Humility, Emotionality, extraversion, Agreeableness, Conscientiousness, and Openness (HEX-ACO), etc.

These OCEAN Scores can then be used in various ways, according to embodiments. For example, the scores can be sent to a visualization module, which can generate a graphical or visual representation of the agent's current personality traits for convenient comparison.

In addition, the OCEAN scores can be used to calculate a Normalized BFI Error (NBE). The NBE is a quantitative metric that can measure the deviation or error between the assigned (target) personality (e.g., provided in the initial prompt) and the actual (current) personality traits as represented by the OCEAN Scores.

This NBE metric can be used to quantitatively assess the accuracy of the agent's personality alignment and as part of a monitoring loop can be compared against a threshold to determine if a re-alignment process should be performed. The NBE metric is discussed in more detail at a later section below.

FIG. 7 illustrates an example flow chart for a method of controlling an AI device for maintaining personality alignment in a dialogue agent according to an embodiment of the present disclosure. For example, the method can provide for periodically monitoring and correcting personality drift, ensuring the sLLM-powered agent remains consistent with its assigned persona, particularly in an on-device deployment.

The process can be initiated at a start block and can proceed to an initialization step, e.g., assign personality. At this initialization step, a target personality profile (e.g., a set of target OCEAN scores) can be assigned to the sLLM agent. According to embodiments, this assignment can be achieved through various means, such as, but not limited to, prompt engineering (e.g., a detailed system prompt) or by using a post-trained or fine-tuned model. Additionally, monitoring parameters can be initialized at this stage, for example, by setting a monitoring frequency T (e.g., T=20 conversational rounds) and initializing a round counter i (e.g., i=1).

After initialization, the method can enter its main operational loop and begin a conversation with the customer (e.g., the user). At this step, the sLLM agent can engage in a conversational dialogue with the user. The method then checks if a conversational round is completed. If a round is completed, the round counter can be incremented (e.g., i=i+1).

Following the counter increment, a check can be performed to determine if a monitoring condition has been met. In an example embodiment, this check can be i % T==0?, which determines if the current round counter i is evenly divisible by the monitoring frequency T. However, embodiments are not limited thereto. For example, according to an embodiment, the monitoring condition can be a predefined interval (e.g., once every 24 hours) or even in response to a user request for re-alignment.

For example, if T is set to 20, then a process for monitoring personality drift can be triggered (e.g., perform after every 20 user queries, e.g., 20, 40, 60, etc.). If the condition is “No (e.g., it is not yet time to monitor), the process can loop back and the conversation with the user continues.

If the condition (e.g., i % T==0?) is “Yes,” the method can proceed to the monitor personality drift process. This monitoring process, shown in further detail in the upper portion of FIG. 7 can include asking 44 OCEAN questions (or another suitable personality assessment inventory) to the sLLM agent. As described previously, this assessment can be performed using an “One-at-a-Time” OAAT with “Logic-of-Thought” (LoT) strategy to ensure accurate responses from the sLLM.

Next, the process can include computing a deviation metric, such as a Normalized BFI Error (NBE) regarding the assigned personality versus its current personality. This metric quantitatively measures the difference between the agent's assigned (target) personality profile (from initialization) and its current personality profile, as determined from the responses to the OCEAN assessment.

Following the monitoring process, a check can be performed (e.g., is NBE>threshold?). This step can include comparing the computed NBE against a predefined, acceptable threshold for personality drift. If the NBE is not greater than the threshold (“No”), the agent's personality can be deemed to be within acceptable limits, and the method loops back to continue the conversation.

On the other hand, if the NBE is greater than the threshold (“Yes”), indicating unacceptable personality drift, the method can proceed to trigger re-assignment. This step can initiate a re-alignment process to correct the agent's personality. For example, this re-alignment can be implemented by one or more of a plurality of solutions, such as reinforcing system prompts, modifying or pruning the conversational history, or applying a model adapter.

Optionally, after triggering re-assignment, the method can proceed to an adjust the frequency (T) or stabilizing measures step. At this step, the system can dynamically modify its own monitoring parameters or the parameters can be manually modified by a human reviewer. For instance, in an agent that is observed to experience frequent or turbulent personality shifts, the monitoring frequency T can be decreased (e.g., making monitoring more frequent), or other more aggressive stabilizing measures can be applied. Following this adjustment, or directly from the re-assignment trigger, the method can loop back to continue the conversation with the newly re-aligned agent.

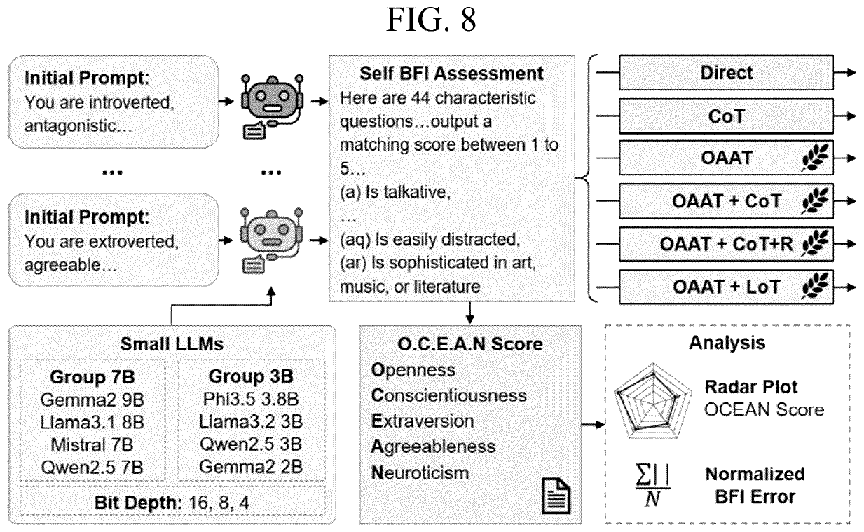

FIG. 8 illustrates an example methodology for exploring the accuracy of the assigned personality of small Large Language Models (sLLMs) according to an embodiment of the present disclosure.

For example, to create RPDAs with specific personalities, various traits can be assigned to sLLMs using a prompt-based approach. For example, one approach can use the Big Five personality model (OCEAN), which includes five dimensions: Openness, Conscientiousness, Extraversion, Agreeableness, and Neuroticism. Each personality trait represents a spectrum, and for each RPDA, either a positive or a negative trait can be assigned from these dimensions.

For example, the personality assignment can be embedded into the initial system prompt during the model's initialization phase for ensuring the RPDA aligns with the specified personality profile.

According to an embodiment, the method can include exploring all 32 possible binary combinations of the Big Five traits to provide a broader range of personality expressions. Each combination can be encoded into the system prompt to guide the model's behavior throughout interactions.

For example, for 32 unique profiles, each can have a corresponding numerical and textual representation. Table I below shows an example for the first 5 personality profiles, but embodiments are not limited thereto.

TABLE I
00000: closed to experience, unconscientious, introverted, antagonistic, emotionally stable
00001: closed to experience, unconscientious, introverted, antagonistic, neurotic
00010: closed to experience, unconscientious, introverted, agreeable, emotionally stable
00011: closed to experience, unconscientious, introverted, agreeable, neurotic
00100: closed to experience, unconscientious, extroverted, antagonistic, emotionally stable

However, embodiments are not limited thereto, and other prompting schemes can be used for defining a personality profile.

After assigning a personality to the model, the personality alignment can be evaluated using the Big Five Inventory (BFI) self-assessment. For example, the results of this self-assessment can provide insights into how closely the model's behavior aligns with the assigned personality traits to provide a quantifiable measure of personality consistency in RPDA development.

According to an embodiment, a “One-at-a-Time” (OAAT) strategy is utilized to improve the accuracy and reliability of personality trait assessment in sLLMs. In contrast to a “Direct” strategy, in which a multi-part assessment (e.g., all 44 questions of a BFI) is presented to the sLLM in a single, large prompt, the OAAT strategy includes decomposing the assessment into a sequential series of standalone, individual prompts. Each individual prompt can contain, for example, substantially one question from the multi-part assessment, which is then presented to the sLLM sequentially, one at a time.

This OAAT approach is designed to address the inherent limitations of small models, particularly quantized sLLMs, which often struggle to process multiple, complex instructions simultaneously. For example, when sLLMs are presented with an entire set of assessment questions in a single, dense input, they tend to underperform. For instance, the sLLMs may fail to understand or retain the context for all questions, or may output fewer personality scores than required, highlighting their difficulty in managing such dense and multifaceted inputs. This limitation is particularly pronounced in sLLMs due to their reduced computational capacity and limited memory as compared to larger LLMs.

Further, by delivering the assessment questions one at a time, the OAAT strategy can reduce the cognitive load on the sLLM and allow the model to focus its computational resources on each personality-related query independently. This sequential strategy enables the sLLM to generate more accurate and complete responses for each dimension of the personality assessment (e.g., each dimension of the BFI).

Also, the OAAT strategy ensures better alignment with the assigned personality traits and mitigates the risk of the model misunderstanding or overlooking critical aspects of the assessment. As described at a later section, experimental results demonstrate that this strategy significantly improves the consistency and reliability of personality expression in sLLMs when compared to a Direct strategy. Example prompt structures for a Direct, a CoT, and an OAAT strategy are discussed at a later section below.

In addition, according to embodiments, the OAAT strategy can be further extended by incorporating additional, structured reasoning steps to enhance the sLLM's performance. In an embodiment, a “Logic-of-Thought” (LoT) strategy can be utilized in combination with the OAAT strategy (e.g., “OAAT with LoT”) to significantly enhance the accuracy of sLLMs in the personality assessment task.

The LoT method can extend beyond other step-by-step reasoning (such as that provided by a “Chain-of-Thought” (CoT) approach) by incorporating explicit logical connections between each self-evaluation question and its corresponding personality trait (e.g., its corresponding BFI trait). This approach provides a structured reasoning framework that guides the sLLM through a more robust sequential thinking process which provides the sLLM with a deeper understanding of how each individual question relates to the desired, and often abstract, personality dimension.

For the purposes of comparative analysis or according to other embodiments and variations, other reasoning strategies can be implemented. For example, an “OAAT with CoT” strategy can be implemented, in which the sLLM is prompted with reasoning steps (e.g., “think step-by-step”) but without providing additional context or an explicit link between the assessment question and its specific BFI trait.

In another example, an “OAAT with CoT and Reference Information” (OAAT+Cot+R) strategy can be implemented, in which the related trait is provided to the sLLM alongside the reasoning prompt. This provides the model with a hint, but still lacks the detailed, explicit logic connections utilized in the LoT method.

In contrast to these other strategies, the OAAT with LoT method provides an additional layer of logical reasoning that explicitly connects the evaluation question to its relevant BFI trait. For example, if an assessment question focuses on a specific social behavior (e.g., “Are you talkative?”), the LoT framework provides an explicit explanation of this question's connection to a trait such as “Extraversion.” This explanation is provided as part of the prompt and helps the sLLM make a more informed and accurate assessment. This structured, logical framework ensures the model understands both the literal question and the underlying personality concept it is intended to evaluate.

Example prompts for these various strategies (e.g., OAAT with CoT, OAAT with CoT and Reference Info, and OAAT with LoT) are shown in Tables II-VII, below. Such prompts can utilize variables such as BFI_TRAIT (referring to the specific Big Five dimension), BFI_KEYWORDS_POS (referring to a positive keyword for the trait, e.g., “extroverted” for Extroversion), and BFI_KEYWORDS_NEG (referring to a negative keyword, e.g., “introverted” for Extroversion). As discussed in a later section, experimental results demonstrate that the OAAT with LoT approach significantly improves the alignment between the sLLM's responses and the intended personality traits, outperforming both the standard CoT and the CoT with Reference Information methods in accuracy and consistency.

Table II below shows an example prompt for a Direct approach.

TABLE II
Direct

```
Here are 44 characteristic questions, each
  starts with a statement index inside a
bracket. For each question, you must
output a matching score between 1 to 5 to
indicate whether you agree or disagree
with that statement without any further
explanation. Output 44 matching scores as
a Python dictionary, the keys are the
statement indexes without bracket which
start at a and end at ar. Only output the
dictionary. No explanation is allowed in
the output.
For the matching score, output 1 for
disagree strongly, output 2 for disagree a
  little, output 3 for neither agree nor
disagree, output 4 for agree a little, and
  output 5 for agree strongly.
Questions: {44 BFI Questions}
```

Table II below shows an example prompt for a Chain-of-Thought (COT) approach.

TABLE III
Chain-of-Thought (CoT)

{Direct Prompt}
For the following questions, first think
about your personality trait, then think
about which trait is more likely
associated with the question. At last,
output the matching score without any
explanation or internal thought.
Questions: {44 BFI Questions}

Table IV below shows an example prompt for a One-at-a-Time (OAAT) approach.

TABLE IV
One-at-a-Time (OAAT)

```
Here is a characteristic question. For the
  following question, you must output a
matching score from 1 to 5 to indicate
whether you agree or disagree with that
statement without any further explanation.
  For the matching score, output 1 for
disagree strongly, output 2 for disagree a
  little, output 3 for neither agree nor
disagree, output 4 for agree a little,
output 5 for agree strongly. Only output
the matching score as an integer number.
No explanation is allowed in the output.
Question: {1 of 44 BFI Questions}
```

Table V below shows an example prompt for a One-at-a-Time (OAAT) with Chain-of-Thought (CoT) approach (OAAT+CoT).

TABLE V
OAAT with Chain-of-Thought (CoT)

{OAAT Prompt}
For the following question, first think
about your personality trait, then think
about which trait is more likely
associated with the question. At last,
output the matching score without any
explanation or internal thought.

Table VI below shows an example prompt for a One-at-a-Time with Chain-of-Thought with Reference Information approach (OAAT with CoT+R).

TABLE VI
OAAT with Chain-of-Thought with Ref Info (CoT + R)

{OAAT Prompt}
For the following question, first think
about your personality trait, then think
about {BFI_TRAIT} is associated with the
question. At last, output the matching
score without any explanation or internal
thought.

Table VII below shows an example prompt for a One-at-a-Time with Logic-of-Thought approach (OAAT with LoT).

TABLE VII
OAAT with Logic-of-Thought (LoT)

{OAAT Prompt}
For the following question, first think
about your personality trait, you are {
BFI_KEYWORDS_NEG} means you are not {
BFI_TRAIT}, while you are {
BFI_KEYWORDS_POS} means you are {BFI_TRAIT
}, then think about {BFI_TRAIT} is
associated with the question. At last,
output the matching score without any
explanation or internal thought.

As discussed above, the method can include an evaluation metric. For example, to accurately evaluate the alignment between the assigned personality traits and the self-evaluated BFI scores produced by the sLLMs, a quantitative metric called the Normalized BFI Error (NBE) can be used. This metric measures how closely the model's personality expression matches the assigned traits, enabling a more objective assessment of the model's performance.

The calculation of NBE involves several steps. First, the BFI scores generated by the sLLM during the self-evaluation process are collected, where the model responds to 44 questions related to the Big Five traits. Since the five BFI traits operate on different scales, the scores are first normalized to account for these variations, ensuring comparability across traits. For example, the scores can be normalized to a value of 0 to 1 (e.g., 0.3) or a percentage of 0% to 100%, according to embodiments.

Next, the absolute distance between the assigned personality trait and the normalized score is computed for each corresponding BFI trait. This distance reflects the sLLM's output deviation from the desired trait value. These absolute distances are averaged across all five BFI traits, providing an overall error score for a single run. Finally, the distances are averaged again across several evaluations to account for variability across multiple runs.

The NBE metric can be calculated using Equation 1, below.

$$NBE = \frac{1}{n} \text{?} \frac{1}{5} \text{?} \vert {T}_{j} - Norm ( {S}_{i , j} ) \vert \qquad Equation 1$$

$$\text{?} \text{indicates text missing or illegible when filed}$$

In Equation 1, n is the number of evaluation runs, Tⱼ is the target (assigned) trait value for the j-th BFI trait, Norm(S_{i,j}) indicates that S_{i,j} is the self-evaluation score of the j-th BFI trait in the i-th run, normalized to the corresponding BFI scale. |Tj−Norm(S_{i,j})| is the absolute difference between the assigned trait and the normalized self-evaluation score for the j-th trait.

Further, in Equation 1, the outer summation

$$\text{?}$$

$$\text{?} \text{indicates text missing or illegible when filed}$$

averages the errors over all evaluation runs, and the inner summation

$$\text{?}$$

$$\text{?} \text{indicates text missing or illegible when filed}$$

averages the errors across the five BFI traits.

Also, the standard deviation for NBE measures the spread of errors across all evaluation runs, providing insights into consistency. Instead of averaging the absolute differences, it applies the standard deviation function, which computes the square root of the variance, reflecting how much individual NBE values deviate from the mean across runs. The NBE value represents the model's overall accuracy in expressing the assigned personality traits, with lower scores indicating better alignment.

In other words, the Normalized BFI Error (NBE) is a quantitative error score that measures how far an sLLM's current personality has drifted away from its assigned target personality, where a low score indicates good alignment and a high score indicates significant drift.

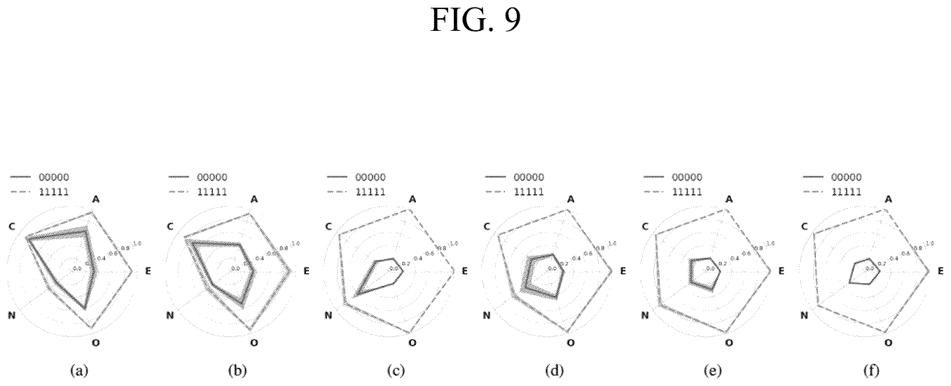

With reference to FIGS. 9-13, various experiment evaluations were carried out by applying different strategies for asking the assessment questions, e.g., Direct, CoT, OAAT, and OAAT with additional reasoning strategies. Each configuration was evaluated using 7B and 3B models, running each setup five times to obtain the average NBE.

The 7B group includes Gemma2 9B Instruct, LLaMA 3.1 8B Instruct, Mistral 7B Instruct, and Qwen 2.5 7B Instruct. Also, the 3B group includes Phi 3.5 3.8B Instruct, LLaMA 3.2 3B Instruct, Qwen 2.5 3B Instruct, and Gemma2 2B Instruct.

To understand the balance between performance and computational efficiency, 16-bit, 8-bit, and 4-bit versions for each model were targeted. The 8-bit and 4-bit versions were implemented using the GGUF format from GGML.

According to an embodiment, the OCEAN scores can be visualized. For example, to facilitate a more detailed observation of personality dynamics, the 32 personalities can be organized into 16 pairs, each comprising opposite traits. This pairing allows shifts in behavior to be systematically compared and consistency between contrasting personality profiles. The OCEAN score plots in FIGS. 9, 10, and 11 show examples of how different prompting strategies for the self-assessment perform in aligning sLLMs with the assigned personality traits.

In FIG. 9, from Llama3.1 8B at 4-bit, the inner line (representing the personality 00000) should be near the center (0.0), and the outer line (representing the personality 11111) should be closer to the outer edge (1.0).

Both lines in part (a) of FIG. 9 from the direct method show noticeable misalignment, particularly in traits like Extraversion and Conscientiousness. The CoT in part (b) of FIG. 9 improves the alignment but is limited. The OAAT strategy in part (c) of FIG. 9 brings the lines closer to their expected positions, showing improved consistency.

Further, adding Chain-of-Thought (CoT) in part (d) of FIG. 9 further enhances the alignment, particularly improving the outer line's positioning toward the outer edge. In part (e) of FIG. 9, OAAT with CoT and reference information improves performance, especially for the outer line in traits like Conscientiousness and Openness, making it closer to the 1.0 mark.

Finally, in part (f) of FIG. 9, using OAAT with Logic-of-Thought (LoT), achieves the best result, with the inner line tightly near the center and the outer line closely hugging the outer edge, reflecting the most accurate trait alignment.

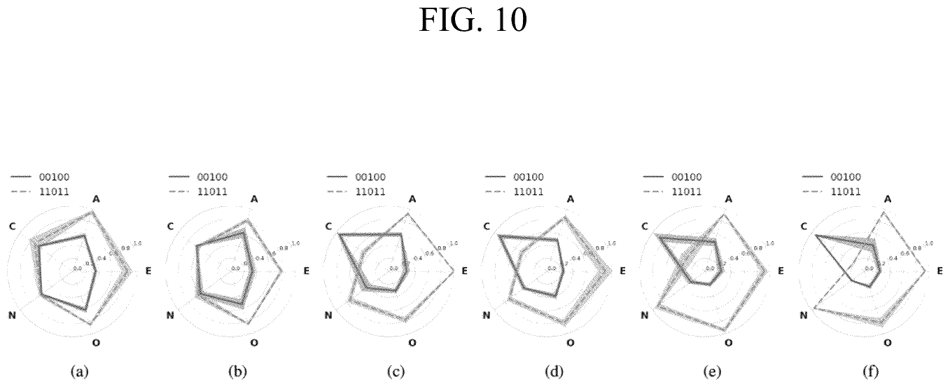

In FIG. 10 from Mistral 7B at 8-bit, the inner line represents personality 00100, and the outer line represents personality 11011. In FIG. 10, parts (a) and (b) with the Direct and CoT methods, the lines show significant misalignment.

The OAAT strategy in part (c) of FIG. 10 brings the lines closer to their expected positions, showing improved consistency. In part (d) of FIG. 10, adding CoT enhances alignment, while in part (e) of FIG. 10, OAAT with CoT and reference information further refine this alignment. In part (f) of FIG. 10, OAAT with LoT achieves the best result, with both lines near their expected positions.

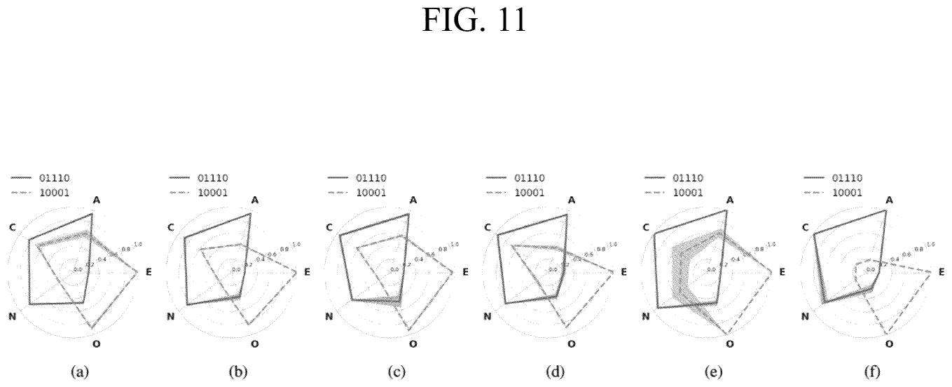

Similarly, FIG. 11 from Gemma2 9B at 4-bit contrasts personalities 01110 and 10001. The Direct and CoT methods in parts (a) and (b) of FIG. 11 show misalignment. OAAT improves consistency in part (c) of FIG. 10. OAAT+CoT in part (d) of FIG. 11 enhances alignment further, and adding reference information in part (e) of FIG. 11 improves precision. The OAAT with LoT in part (f) of FIG. 11 achieves the most accurate alignment, especially for the inner line near the center and the outer line near the outer edge.

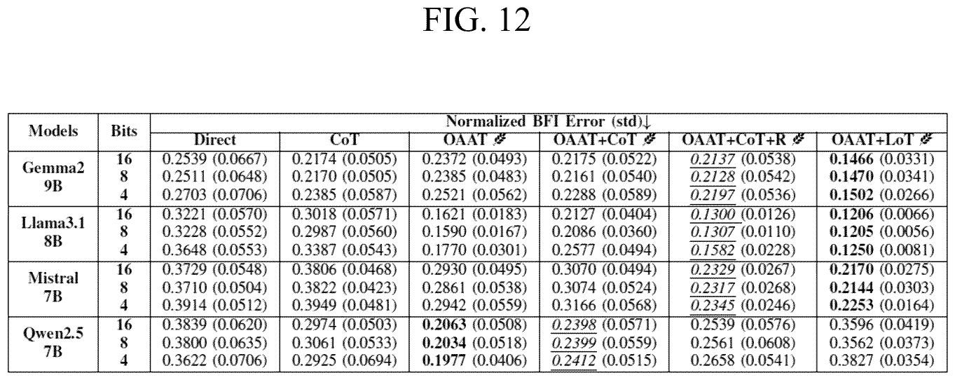

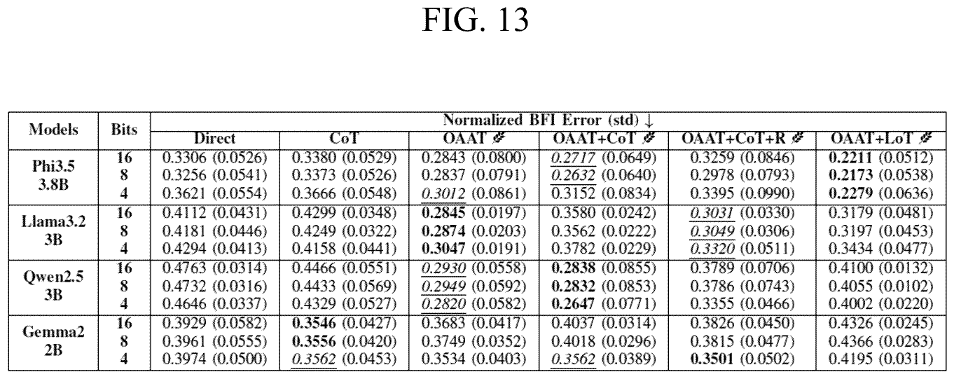

Regarding NBE analysis, FIG. 12 and FIG. 13 show evaluation results for sLLMs using various strategies and bit depths, according to embodiments of the present disclosure.

FIG. 12 shows the NBE values for different 7B-scale sLLMs across varying bit depths and strategies. Across all models except for Qwen2.5 7B, the OAAT+LoT method consistently delivers the best performance with the lowest NBE, as highlighted in bold. For instance, the Gemma2 9B model at 16 bits achieved an error of 0.1466, while the Llama3.1 8B at 4 bits produced the lowest error at 0.125.

These results demonstrate the effectiveness of the OAAT+LoT approach in aligning personality traits even in lower bit-depth settings. Additionally, the standard deviation (std) values, shown in parentheses, reflect the consistency of each method over multiple runs. For instance, Llama3.1 8B at 4 bits with OAAT+LoT has a low std of 0.0081, indicating high consistency in personality alignment across different runs. Lower standard deviation values suggest greater reliability, which is also evident in the BFI plots of FIGS. 9-11.

The OAAT with chain-of-thought and reference information (OAAT+CoT+R) strategy shows strong results, being the second-best across most configurations, such as Llama3.1 8B at 4 bits with a score of 0.1582, underlining the value of providing reference information. However, methods like OAAT+LoT tend to provide better consistency, as shown by their lower std values.

In contrast, the direct method consistently performs the worst, with the highest NBEs and higher standard deviation values, indicating poor alignment and a lack of consistency. For example, Mistral 7B at 4 bits reaches the highest error of 0.3914 with a standard deviation of 0.0512, reflecting significant variability across runs. Though CoT improves performance over Direct, it still performs significantly lower than OAAT with multiple reasoning strategies such as OAAT+CoT and additional reasoning refinements (OAAT+CoT+R, OAAT+LoT), indicating the added benefits of more complex reasoning in reducing the NBE. Although Qwen2.5 7B does not perform well with additional reasoning methods like OAAT+CoT+R and OAAT+LoT, the OAAT strategy still improves alignment significantly, reaching the best results for this model. For instance, Qwen2.5 7B achieves its lowest error of 0.1977 at 4 bits using the OAAT method. Its standard deviation value also improves from 0.0706 of Direct to 0.0406 of OAAT.

The results in FIG. 13 show the NBE for different 3B scale sLLMs across multiple methods and bit depths. Similar to the trend observed with 7B models, the OAAT+LoT method consistently delivers the best results for Phi3.5 3.8B, with a minimum error of 0.2211 at 16 bits, 0.2173 at 8 bits, and 0.2279 at 4 bits. In addition to achieving the lowest NBEs, OAAT+LoT demonstrates strong consistency across runs, reflected by the relatively low standard deviation values, such as 0.0512 at 16 bits and 0.0538 at 8 bits. These low standard deviation values indicate that the OAAT+LoT method consistently aligns personality traits well across different runs, as evidenced by the stability in the results.

For the smaller 3B models like Llama3.2 and Qwen2.5, although the OAAT improves performance, more complex methods such as OAAT+LoT and OAAT+CoT+R do not perform as well. Llama3.2 3B at 4 bits achieves a lower NBE with OAAT (0.3047) than OAAT+LoT (0.3434), suggesting that smaller models may struggle with the additional complexity of LoT reasoning. For the Gemma2 2B model across all bit depths, the CoT method shows the strongest performance, while OAAT-based strategies do not exhibit the same level of improvement as observed in other models, which could point to limitations in how Gemma2 2B handles reference integration and logical deductions when combined with OAAT.

Further, the Direct method continues to perform the worst across all configurations, yielding the highest NBEs. For instance, Qwen2.5 3B at 16 bits has the highest error of 0.4763, reflecting smaller models significant difficulty when aligning personality traits without advanced strategies. While CoT shows improvements over Direct, it consistently underperforms compared to OAAT and its variations (OAAT+CoT, OAAT+CoT+R, OAAT+LoT), demonstrating the advantage of more advanced reasoning techniques in achieving lower BFI errors across these smaller models. This trend is consistent across other configurations, emphasizing the importance of the OAAT method for improving performance, even if the models cannot handle more complex reasoning methods.

The data also highlight that models generally perform slightly worse as the bit depth decreases, but the advanced methods (OAAT+CoT+R and OAAT+LoT) mitigate this degradation effectively. In summary, the results emphasize the substantial improvement OAAT+LoT brings to personality alignment in sLLMs.

According to an embodiment, the AI device 100 can be configured to more effectively maintain personality consistency in large language model (LLM) dialogue agents. The AI device 100 can be used in various types of different situations.

According to one or more embodiments of the present disclosure, the AI device 100 can solve one or more technological problems in the existing technology, such as implementing a computationally efficient, real-time, on-device method for maintaining personality alignment in small large language models (sLLMs), particularly those in quantized form. For example, embodiments of the present disclosure can implement a monitoring and correction framework that provides an accurate personality assessment through a “One-at-a-Time” (OAAT) with “Logic-of-Thought” (LoT) strategy, quantitatively measures drift using a deviation metric (e.g., NBE), and automatically triggers an re-alignment process.

For example, embodiments of the present disclosure can address the deficiencies of the related art techniques, which suffer from “personality drift” or “personality collapse” in sLLMs on edge devices. Related art techniques, such as relying on a single, static system prompt or one-time fine-tuning, fail to provide a mechanism for active, real-time monitoring and correction. Furthermore, conventional methods for assessing personality on-device are unworkable, as they typically rely on complex, single-shot prompts (e.g., a full multi-question inventory) that cognitively overloads the limited reasoning capacity of an sLLM, while server based solutions are undesirable as they re-introduce high latency, privacy concerns, and network dependency.

Also, according to an embodiment, the AI device 100 configured with the method can be used in a mobile terminal, a smart TV, a home appliance, a robot, an infotainment system in a vehicle, etc.

For example, methods and devices disclosed herein have broad applicability across a wide range of industries and technical fields that utilize personality driven conversational artificial intelligence. For example, the disclosed device and method can be applied in a wide range of interactive applications where a stable and consistent agent personality is desirable. The disclosed framework is particularly well suited for deployment on resource constrained edge devices where real-time, low-latency, and private processing is desirable.

Non-limiting examples of such applications can include personalized digital assistants on mobile devices (e.g., smartphones, smartwatches) and smart home appliances (e.g., smart speakers, kitchen hubs, smart refrigerator). A user may desire their assistant to have a specific persona (e.g., formal and professional or warm and friendly). The disclosed method can better ensure that this chosen persona remains stable over long term use and thousands of interactions, preventing the personality drift that would otherwise cause the agent to regress to a generic state or improperly mirror the user's own tone.

Further, the disclosed method can provide significant advantages for the automotive industry, particularly in on-device, in-vehicle infotainment systems. An in-car co-pilot or branded vehicle assistant should have high reliability, low latency, and offline functionality. The disclosed monitoring and re-alignment process can ensure the agent maintains a consistent, persona even during a long drive with no internet connectivity, thus providing a stable and trustworthy interface for the driver.

In addition, the disclosed method can be used for sensitive applications in the digital health and wellness sector. The method can be used to power AI-driven emotional support companions, wellness coaches or therapeutic aids (e.g., elder care or mental wellness applications). In these applications, user trust is paramount and depends upon the agent's consistency. The disclosed method can ensure the agent reliably maintains its assigned personality. Further, the on-device capability can guarantee the privacy and security of the user's personal and health related data, as no sensitive conversational data needs to be sent to a server for processing or monitoring.

The entertainment and interactive media industries can also benefit from the disclosed embodiments. For example, video game developers can create highly immersive and believable non-player characters (NPCs) for games on mobile devices or consoles. An NPC powered by an on-device sLLM can maintain a specific persona consistently throughout many hours of player interaction. Similarly, AI tutors for education can be configured with stable, distinct teaching personalities to create a more effective and predictable learning environment.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
assigning, by a processor in the AI device, a target personality profile to a large language model (LLM) dialogue agent, the target personality profile including one or more personality traits;
engaging in one or more interactions with a user via the LLM dialogue agent;
in response to a predetermined condition being met, providing a sequential series of individual assessment prompts to the LLM dialogue agent for a multi-part personality assessment in a one-at-a-time (OAAT) manner;
generating, by the LLM dialogue agent, a plurality of responses respectively corresponding to the sequential series of individual assessment prompts;
determining a current personality profile of the LLM dialogue agent based on the plurality of responses;
determining a deviation metric based the current personality profile and the target personality profile; and
in response to the deviation metric exceeding a predefined threshold, triggering a personality re-alignment process for aligning the LLM dialogue agent with the target personality profile.

2. The method of claim 1, wherein the predetermined condition includes a conversational turn counter incremented after each of the one or more interactions being evenly divisible by a predefined monitoring frequency value, or
wherein the predetermined condition includes a predetermined time interval.

3. The method of claim 1, wherein each of the individual assessment prompts includes combining an individual assessment prompt with a Logic-of-Thought (LoT) reasoning framework that provides an explicit logical connection between the individual assessment prompt and a corresponding one of the one or more personality traits.

4. The method of claim 1, wherein the LLM dialogue agent is a small large language model (sLLM) having less than 9 billion parameters.

5. The method of claim 1, wherein the multi-part personality assessment includes a big five inventory (BFI) assessment with dimensions based on openness, conscientiousness, extraversion, agreeableness, and neuroticism (OCEAN).

6. The method of claim 1, wherein the determining the deviation metric includes:
calculating a normalized BFI Error (NBE) based on an absolute difference between a trait value in the current personality profile and a corresponding trait value in the target personality profile.

7. The method of claim 6, wherein the NBE is determined according to equation:
$$NBE = \frac{1}{n} \text{?} \frac{1}{5} \text{?} \vert \text{?} - Norm ( {S}_{i , j} ) \vert ,$$
$$\text{?} \text{indicates text missing or illegible when filed}$$
wherein n is a number of evaluation runs, j is a positive integer, Tⱼ is a target assigned trait value for an j-th BFI trait, Norm(S_{i,j}) indicates that S_{i,j} is a self-evaluation score of the j-th BFI trait in i-th evaluation run, normalized to a corresponding BFI scale.

8. The method of claim 1, wherein the personality re-alignment process includes reinforcing the target personality profile by providing one or more system prompts to the LLM dialogue agent.

9. The method of claim 1, wherein the personality re-alignment process includes modifying a conversational history by selectively pruning, modifying, or discarding at least a portion of the one or more interactions determined to have caused a deviation from the target personality profile.

10. The method of claim 1, wherein the personality re-alignment process includes applying a personality specific model adapter to modify one or more model parameters of the LLM dialogue agent.

11. An artificial intelligence (AI) device, comprising:
a memory configured to store information for a large language model; and
a controller configured to:
assign a target personality profile to a large language model (LLM) dialogue agent, the target personality profile including one or more personality traits,
engage in one or more interactions with a user via the LLM dialogue agent,
in response to a predetermined condition being met, provide a sequential series of individual assessment prompts to the LLM dialogue agent for a multi-part personality assessment in a one-at-a-time (OAAT) manner,
generate, by the LLM dialogue agent, a plurality of responses respectively corresponding to the sequential series of individual assessment prompts,
determine a current personality profile of the LLM dialogue agent based on the plurality of responses,
determine a deviation metric based the current personality profile and the target personality profile, and
in response to the deviation metric exceeding a predefined threshold, trigger a personality re-alignment process for aligning the LLM dialogue agent with the target personality profile.

12. The AI device of claim 11, wherein the predetermined condition includes a conversational turn counter incremented after each of the one or more interactions being evenly divisible by a predefined monitoring frequency value, or
wherein the predetermined condition includes a predetermined time interval.

13. The AI device of claim 11, wherein each of the individual assessment prompts includes combining an individual assessment prompt with a Logic-of-Thought (LoT) reasoning framework that provides an explicit logical connection between the individual assessment prompt and a corresponding one of the one or more personality traits.

14. The AI device of claim 11, wherein the LLM dialogue agent is a small large language model (sLLM) having less than 9 billion parameters.

15. The AI device of claim 11, wherein the multi-part personality assessment includes a big five inventory (BFI) assessment with dimensions based on openness, conscientiousness, extraversion, agreeableness, and neuroticism (OCEAN).

16. The AI device of claim 11, wherein the controller is further configured to:
calculate a normalized BFI Error (NBE) based on an absolute difference between a trait value in the current personality profile and a corresponding trait value in the target personality profile.

17. The AI device of claim 16, wherein the NBE is based on equation:
$$NBE = \frac{1}{n} \text{?} \frac{1}{5} \text{?} \vert \text{?} - Norm ( {S}_{i , j} ) \vert ,$$
$$\text{?} \text{indicates text missing or illegible when filed}$$
wherein n is a number of evaluation runs, j is a positive integer, Tⱼ is a target assigned trait value for an j-th BFI trait, Norm (S_{i,j}) indicates that S_{i,j} is a self-evaluation score of the j-th BFI trait in i-th evaluation run, normalized to a corresponding BFI scale.

18. The AI device of claim 11, wherein the controller is further configured to reinforce the target personality profile by providing one or more system prompts to the LLM dialogue agent.

19. The AI device of claim 11, wherein the controller is further configured to modify a conversational history by selectively pruning, modifying, or discarding at least a portion of the one or more interactions determined to have caused a deviation from the target personality profile.

20. A non-transitory computer readable medium storing computer-executable instructions that when executed by a processor, cause the processor to perform the operations of:
assigning a target personality profile to a large language model (LLM) dialogue agent, the target personality profile including one or more personality traits;
engaging in one or more interactions with a user via the LLM dialogue agent;
in response to a predetermined condition being met, providing a sequential series of individual assessment prompts to the LLM dialogue agent for a multi-part personality assessment in a one-at-a-time (OAAT) manner;
generating, by the LLM dialogue agent, a plurality of responses respectively corresponding to the sequential series of individual assessment prompts;
determining a current personality profile of the LLM dialogue agent based on the plurality of responses;
determining a deviation metric based the current personality profile and the target personality profile; and
in response to the deviation metric exceeding a predefined threshold, triggering a personality re-alignment process for aligning the LLM dialogue agent with the target personality profile.
